(19) United States
(12) Patent Application Publication
(10) Pub. No.: US 2013/0132192 A1
(43) Pub. Date: May 23, 2013

(54) E-COMMERCE VALUATION SYSTEM AND METHOD

(71) Applicants: JOHN ROBERT KRUKOWSKI, Bangkok (TH); Thomas Gerard Williams, Bangkok (TH)

(72) Inventors: JOHN ROBERT KRUKOWSKI, Bangkok (TH); Thomas Gerard Williams, Bangkok (TH)

(21) Appl. No.: 13/474,646

(22) Filed: May 17, 2012

Related U.S. Application Data
(60) Provisional application No. 61/488,111, filed on May 19, 2011.

(51) Int. Cl. G06Q 30/06

(52) U.S. Cl. CPC G06Q 30/0613
USPC 705/14.51; 705/14.26

(57) ABSTRACT

Embodiments of the present disclosure provide new systems and methods for e-commerce, or online product and service sales. These systems and methods allow for a vendor to list a product on which buyers can place puts. Vendors can then evaluate the puts, learning valuation information about their listed item, and respond to the puts with an offer or rejection. The buyers may then redeem offers at a merchant using a physical or virtual coupon.

This application is claims priority to U.S. Provisional Patent No. 61/488,111, to Krukowski et al., filed on May 19, 2011, and entitled “E-COMMERCE VALUATION SYSTEM AND METHOD.”

### BACKGROUND OF THE INVENTION

1. Field of the Invention

The invention relates generally to methods and systems for e-commerce or online product sales and, more specifically, to methods and systems for determining valuation in e-commerce and carrying out e-commerce transactions.

2. Description of the Related Art

More particularly, the present invention is in the field of online product sales between the vendor and the buyer where a third party merchant actually completes the sale and provides the product, whether this completion is online or in person.

E-commerce consists of the buying and selling of products or services on the internet, otherwise known as internet shopping. As the use of the Internet has grown, so has e-commerce. Both virtual and real items are sold via e-commerce. E-commerce may be conducted between businesses, between businesses and consumers, open to all parties, or only open to pre-qualified participants. Numerous online sales portals exist. Some examples of online sales portals include both businesses, which only exist online, such as amazon.com or ebay.com, and those which also have existing stores, such as bestbuy.com or macys.com. Some online sales portals offer a bidding system. Some “guarantee” the cheapest price. Many tout themselves as offering the cheapest price on a particular product. All are oriented towards the buyer or customer.

Generally, e-commerce or Internet shopping involves a customer or buyer accessing a website, viewing products or services, selecting a delivery option, and providing payment information to complete a purchase. This provides customers with a lot of flexibility. Customers may browse many items choosing one which is best, choose different delivery options, and may begin the shopping process at any time, regardless of business hours. Though the flexibility for customers is high, current systems do not provide adequate tools and flexibility for vendors and merchants to allow them to determine market values of their products and services and collect data regarding sales and incomplete sales. An existing system such as Amazon.com may provide an area for many vendors or merchants to sell their goods, and it may be able to provide data regarding past sales on this website of the same item, however it cannot provide real time or near real time information regarding how much a buyer currently wants to pay for an item and whether those browsing the listing on Amazon.com are actually interested in purchasing the item or not. The existing e-commerce systems fail to address market forces related to global and regional supply and demand issues that could maximize a vendor's market penetration and/or profitability.

### SUMMARY OF THE INVENTION

The present invention is directed to various configurations of an e-commerce system which allows vendors to list items, buyers to place puts on these items, and vendors to provide offers to these buyers based on their puts to purchase these items at a merchant. The difference configurations comprise various arrangements of the system and methods relating to the system allowing the vendor to further valuate item listings based on bids, provide information tracking features, providing anonymity for buyers and additionally creating reward and loyalty systems.

One aspect of the present disclosure provides an e-commerce method for accepting an item listing for sale. The method includes receiving at least one put on the item listing, providing the received put for evaluation. In addition, the method includes receiving a response to the at least one put and providing an output of the response, as a coupon, to be redeemed at a merchant, if valid.

Another aspect of the present disclosure provides an e-commerce system operable on a server computer and accessible through a computer network. The system includes an item listing unit which stores information about items for sale. In addition, the system includes a buyer put unit which accepts at least one buyer put on the listed items. The system further includes a vendor offer unit which accepts vendor offers in response to the buyer puts and a coupon output unit which outputs coupons representing vendor offers.

Yet another aspect of the present disclosure provides a computer program product comprising a non-transitory computer-readable medium including code for accepting an item listing for sale. The computer program product further includes code for receiving at least one put on the item listing. The computer program product also includes code for providing the at least one put for evaluation and code for receiving a response to the at least one put. The computer program product further includes code for providing an output of the response, as a coupon, to be redeemed at a merchant, if valid.

A better understanding of the features and advantages of the present embodiments will be obtained by reference to the following detailed description of the invention and accompanying drawings which set forth illustrative embodiments in which the principles of the invention are utilized.

### BRIEF DESCRIPTION OF THE DRAWINGS

FIG. 1 is a flow chart showing the use of the system in one embodiment of the present invention;

FIG. 2 is a flow chart showing the use of the system in another embodiment of the present invention;

FIG. 3 is an overview of the system in one embodiment of the present invention.

### DETAILED DESCRIPTION OF THE INVENTION

Embodiments of the invention described herein provide new systems and methods for online product sales. Although embodiments of the present invention are discussed with specific reference to merchants, vendors and customers or buyers, it is understood that the methods and systems described herein may be applied to online sales scenarios, e-commerce systems, or any internet shopping platform that involve the sale of products or services online. Overall system architecture and specific algorithms are presented as embodiments of the present invention; however, as stated above, the methods and systems are in no way limited to any particular application.

Although the ordinal terms first, second, etc. may be used herein to describe various elements, components, and/or modules, these elements, components, and/or modules should not be limited by these terms. These terms are only used to distinguish one element, component, and/or module from another. Thus, a first element, component, and/or module discussed below could be termed a second element, component, and/or module without departing from the teachings of the present invention.

The present invention is described herein with reference to certain embodiments, but it is understood that the invention can be embodied in many different forms and should not be construed as limited to the embodiments set forth herein. In particular, the invention is described with reference to certain embodiments where a server is accessed by buyers, merchants, and vendors to complete transactions, but in other embodiments, other entities may also interact with the server or portions of the system may take place outside of the server. The present invention may incorporate the use of any electronic device and communication method for carrying out the system.

Embodiments of the invention are described herein with reference to illustrations that are schematic illustrations of embodiments of the invention. As such, the actual size, components and features can be different, and variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing. The regions illustrated in the figures are schematic in nature and their shapes are not intended to illustrate the precise shape of a feature of a device and are not intended to limit the scope of the invention. Furthermore, components described as being connected or connections may not be direct. Intervening components or connections may exist. Also, components may be shown as one unit but may instead be a collection of components or units.

Some embodiments of the present invention allow vendors, which may be manufacturers, to place items for sale online via this system. Customers or buyers can then browse these items and request to purchase them for a price of their choosing by placing a put. The system may be accessed by buyers, vendors, or merchants, either by website or via an application on an electronic device. Vendors can then browse these puts or price requests and reject, accept or counter these prices, allowing the buyer to purchase the item at the accepted or countered rate for a period of time. If the buyer wants to purchase the item at the accepted price, the buyer can retrieve a coupon or voucher containing the product and price information. The buyer can then provide this voucher to a merchant, either physically or virtually, and purchase the item for the agreed upon price from the merchant or store. In some embodiments, the system may then receive a portion of the proceeds from the purchase.

In some embodiments, these merchants act as the delivery system for the vendor's products. The system can allow for buyers to remain anonymous to vendors and merchants. The system may also allow for vendors to determine market values of the items based on puts placed on the item by buyers. The system may allow vendors to determine the value at a particular time of an item, then generate a coupon or memo of agreement of an agreed upon price for buyers. In some configurations, a vendor and a merchant may be the same party.

The system may also be used to gather information about products, prices, buyer habits, buyer demographics, vendor information, merchant information, and additional system usage data. This data may then be applied for many purposes, such as but not limited to, pricing, marketing information, rewards programs, advertising programs, and industry information. Data may be supplemented with other information, such as, community demographic information obtained from other sources.

Referring now to the invention in more detail,

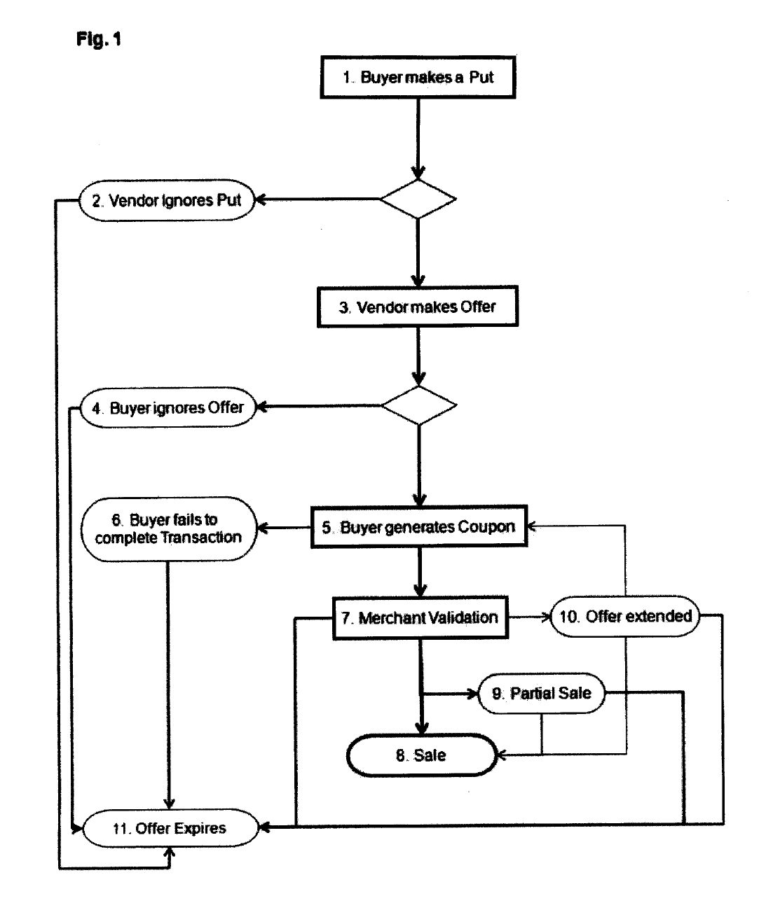

FIG. 1 shows a flow diagram depicting an embodiment of the e-commerce system of the present invention. The system shown in this embodiment is specifically tailored to online product sales between a vendor and a buyer where a third party merchant actually completes the sale and provides the product.

A buyer is an entity that makes a put or bid on an item and acts on any offer made by the vendor or the Vendor Network. A put is the price proposed by the buyer to the vendor for a product. Puts may have a Start Date and an End Date or not be restricted to a time limit. It is defined in formulae as ‘Put’. An offer is the price proposed by the vendor to the buyer. Every offer may have a Start Date and an End Date or may not be restricted to a time frame. It is defined in formulae as ‘Offer’.

The vendor is the entity originating, manufacturing or distributing the product at preferably the highest level possible, but may be at any level. Preferably this would be the global source of the product, but it may be at a lower level. Vendors may be assigned a vendor code which is the unique number assigned to a vendor and is in some embodiments the only reference that a buyer will have to a vendor. The Vendor Network refers to both the vendor and all of its merchants as a group, and the collective of all vendors and their merchants.

The merchant is the point of sale for the product and/or the delivery mechanism for getting the product to the buyer. In some configurations, this may be at a community level, meaning that the sales created through the system may generate sales, profit, employment and local support opportunities. A merchant is generally a physical entity and not a virtual entity, but may also be a virtual entity. A Merchant Code is the unique number assigned to a merchant. A merchant may also be a virtual merchant. A Virtual Merchant is a merchant that is an approved distributor of the vendor, but which does not have a physical location that buyers can visit.

In step 1 of FIG. 1, the buyer makes a put on a product to the vendor. A product is any item offered for sale through the system, or any item that a buyer may wish to have added to the system. It is defined in formulae as ‘P’. The put may have a start and end date. The Put Start Date is the date from which a put is valid. It is defined in formulae as ‘DsP’. The Put End Date is the date on which a put expires. It is defined in formulae as ‘DeP’. The Put Validity Term is the period between 00:00 on the Start Date and 23:59 on the End Date of a put. It is defined in formulae as ‘Pvt’.

Products on the system may include product classification information. This classification information may be used to regulate display of products restricting access to certain products based on various different criteria and classification. Some information that may be included in the classification system may include whether the item is a prohibited import, has offensive imagery, or is restricted by an agreement. This information and other information may be used to exercise content control on the system. A content control system may be used to govern product or product images which are deemed to be sensitive, offensive, or illegal. In some embodiments the Product Classification must be applied to every product loaded onto the system. Classifying a product may be done through a screen where various classifications are selected or deselected. A vendor may set the default classification for all products based on their general classification for all of their products, then make changes to special products. Classifications may include: Adult Content, General Purpose All Ages, Luxury Item, Consumable Item, Dangerous Item, Restricted Item, Service Item, or other classifications. Product images may also have classifications.

In step 2 the vendor has the option of ignoring the put, or alternately to proceed with step 3, where the vendor makes an offer back to the buyer and may impose a time limit on that offer. An offer is the price proposed by the vendor to the buyer. This offer may be equal to, less than or greater than the buyer's put. Offers may have a Start Date and an End Date. It is defined in formulae as ‘Offer’. The Offer Start Date is the date and time that an offer is valid from, preferably in the time zone of the buyer. It is defined in formulae as ‘DsO’. The Offer End Date is the date and time on which an offer expires, preferably in the time zone of the buyer. It is defined in formulae as ‘DeO’. The Offer Validity Term is the period between 00:00 on the Start Date and 23:59 on the End Date of an offer. It is defined in formulae as ‘Ovt’. If the vendor takes step 2 the next action is step 11, discussed below.

If the vendor has made an offer, the buyer has the option of proceeding with either step 4 or step 5. In step 4, the buyer can ignore the offer, leading to step 11. In step 5 the buyer can generate a coupon to be presented to the vendor's participating merchant in order to purchase the item or service.

If the buyer generates a coupon they can then proceed with either step 6 or step 7. In step 6 the buyer chooses not to proceed with the transaction, leading to step 11. In step 7 the merchant validates the coupon from the buyer. Validation may include obtaining or verifying product, buyer, and pricing information.

After validating the coupon, either step 8, step 9 or step 10 occur. In step 8 the buyer completes the purchase. A transaction occurs when a buyer completes the purchase of a product from a vendor through a merchant. It is represented in formula as ‘Tr’. In step 9 the buyer may make a partial purchase. In step 10 the merchant extends the expiration date of the offer resulting in either step 8, or step 11.

In step 11, no sale has been completed and the term of the offer has expired.

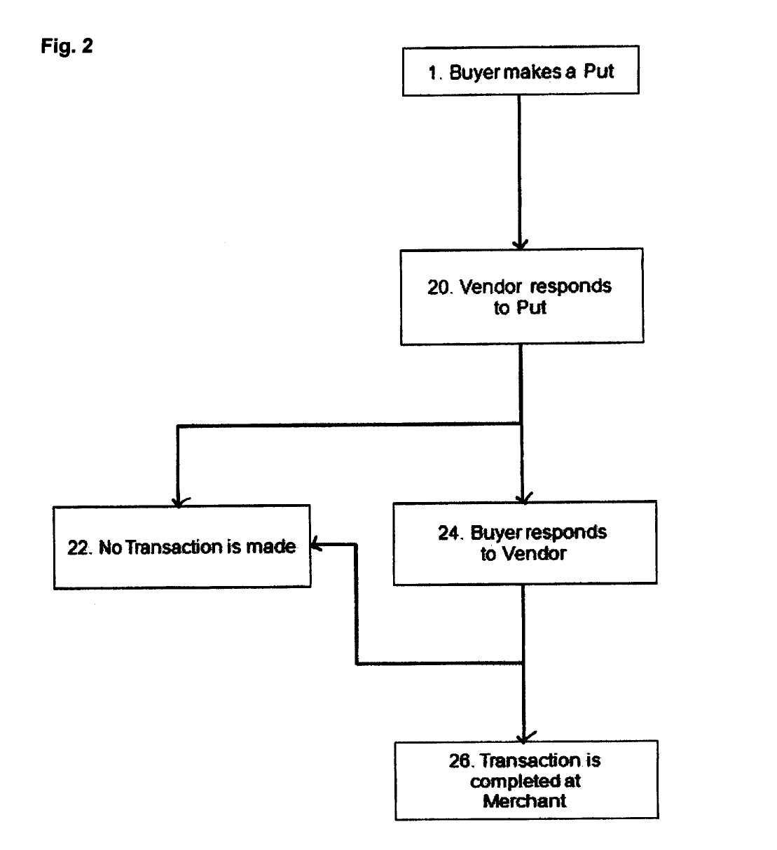

In other embodiments a simplified version of the system may be implemented, as shown in FIG. 2. In step 1 the buyer places a put or bid on an item. In step 20, following step 1, the vendor responds to the put or bid. This may be a rejection by the vendor resulting in no transaction being made (shown by step 22) or the vendor may agree to or counter the put. In the following step the buyer responds to the vendor's counter or agreement. The buyer's response may be to complete the transaction with a merchant, as shown in step 26, or to decide not to make a transaction, resulting in step 22.

In another embodiment, still referring to FIG. 1 a buyer, vendor, and merchant may complete a transaction as outlined in the following steps.

In step 1 the buyer makes a put on a product to the vendor. A buyer generally has a buyer profile which may contain information provided by the buyer and may additionally contain information gathered by the system regarding use of the system. Initial buyer profile information can include information such as email address, country, and post or postal code. This initial data is enhanced through the addition of data regarding for example buying habits, online surveys, in-store surveys, linked suites of services, and IP addresses used. Many other types of information or subsets of this information may be added to the buyer profile. The buyer profile may be used for several functions including to target advertising from vendors or merchants to buyers in a specific area, of a specific gender, income level, or other criteria. Other uses and types of buyer profile information are discussed more thoroughly below.

Though a buyer profile exists with a variety of buyer related information, the system incorporates mechanisms to maintain the buyers' anonymity during transactions and use of the system. In one embodiment this is accomplished, affording the buyer with maximum anonymity by identifying the buyer in the system with a unique buyer code, but in each transaction the buyer is identified by a unique transaction code or virtual buyer code.

The Buyer Code is the unique number assigned to a buyer. The Buyer Code is only visible to the buyer and to the e-commerce system. Vendors and merchants will reference the buyer by the Virtual Buyer Code or transaction code. The Virtual Buyer Code is a unique number that is generated to represent the buyer on each transaction. In effect, the vendor and the merchant can only identify buyers as a number on one particular transaction. After the transaction has been completed or has expired, neither the vendor nor the merchant will be able to identify the buyer within the system. The system will have access to the table that links a buyer with any particular transaction.

In some configurations, that virtual buyer code or transaction code may include information that provides the vendor with information on the buyer's status within the system and certain demographic and buying pattern data. This information may be stored in a variety of manners such as a multiple digit code section.

Merchants and vendors may both have IDs or codes on the system to identify each entity, each of these uniquely assigned to each merchant or vendor. Each merchant and vendor may also have profile and credibility information. In some embodiments, a Merchant Credibility Ranking may be based on the percentage of transactions completed compared to the number of Merchant Validations completed. The formula would be Tr/(Tr+MV). It may be used as an indicator that merchants may be trying to disrupt the system's process to the detriment of both system and the vendor. The Merchant Profile may include all available information related to the merchant including geographical information, multiple contacts, addresses, web presence and more. This information can be used when the merchant is a potential buyer for vendors. The system has the potential to unite merchants in an unofficial but cohesive cooperative and could be used to enhance purchasing power at many levels. Merchants may also be qualified based on type of merchant. This may include such classifications as Boutique Store, Corner Store, Supermarket, Super Store, Warehouse Outlet, or other. The type of store that a buyer chooses to complete the transaction in may help establish the purchasing power or habits of the buyer.

After step 1 the vendor may proceed by either executing step 2 or 3. In step 2 the vendor has the option of ignoring or rejecting the put for any reason. For example, if it considers the value of the put unrealistic or if the system has determined that the buyer is either not a serious purchaser, or if the buyer appears to be using the system to drive a price down, or if the buyer has been identified as being involved in some form of commercial espionage. These characteristics may be identified by information in the virtual buyer code or via other statistics. Proceeding with step 2 results in step 11.

In step 3, after reviewing some or all puts made on that particular product at this point in time, and any data gathered on the buyer in terms of demographics and prior buying patterns, the vendor makes an offer back to the buyer and if desired imposes a time limit on that offer. The vendor has the benefit of being able to review how buyers using the system, for example in all international regions or particular regions, value their product on that particular day or chosen period of time where puts have been entered, and may use that and other information to determine the optimum price to be offered. The offer may match the put, or be higher than the put, or could even be lower than the put. The system may also provide a means to automate offer responses to puts. In one embodiment response algorithms are used for this. Response Algorithms are formulae developed to allow vendors to offer automated offers against puts providing an offer, or classifying offers into various groups for further review. In some embodiments an initial list of algorithms may be defined and vendors may be presented with basic forms that allow them to set the parameters of algorithms so that the offer can be generated.

After step 3, either step 4 or step 5 is taken. In step 4, the buyer can ignore the offer and do nothing. There is no obligation on the buyer to make a purchase but their activities may be tracked and if they make repeated puts for the same product in an effort to drive the price down, they will be identified to the vendor and the vendor may give them the same price they were offered last time or no price at all. This would lead to step 11. In step 5 the buyer can generate a coupon that identifies the buyer, the product, the offer and the offer expiration date. The identification of this information may be plain on the face of the coupon or it may be data stored in some form on the coupon. This coupon may be printed so it can be handed to the vendor's participating merchant, or emailed to the vendor's participating merchant, or reproduced electronically so it can be shown to the vendor's participating merchant. In other embodiments, biometrics may be used to identify the buyer both online and in store. For example, biometrics may be used as or to present the coupon to a merchant.

In some embodiments the coupon has the transaction code and the name of the participating merchants, but not the product name or price. This forces the merchant to validate the coupon to find out what price has been quoted. This validation can be stored in the system and will be indicated in the system, placing the buyer in the merchant's facilities in one way or another. A coupon is an electronic or hard copy confirmation of an offer. It may have an Offer Validity Term defining the End Date of the offer. In some embodiments, if a vendor attempts to validate a coupon after the expiration date then no data related to the offer is available to either the merchant or the buyer. When the merchant attempts to validate the coupon the system is aware of the fact that the buyer is interacting with the merchant and may still be interested in making a purchase.

In some embodiments, the computer response to an invalid coupon invites the buyer to create a new coupon. The merchant can make this request and a response by the vendor may be: the vendor has agreed to extend the Offer End Date and the buyer can purchase the product at the previous offer price, provided the transaction is completed today; this offer was a special price that expired on Offer End Date, but a new offer is provided; or some other alternative. In some embodiments, for transactions under an amount deemed appropriate the coupon will display the Product Name, the list of participating merchants in the area, and a code, symbol or bar-coded number created as follows: Universal Date+Transaction+Product Code+Offer End Date. In other embodiments, the coupon may only display a list of participating merchants in the area and the coding. In still other embodiments, the coupon may display other information or just be encoded with information.

Following step 5, either step 6 or step 7 occurs. In step 6 the buyer may choose not to proceed with the transaction, prior to or after presenting the coupon to the vendor's participating merchant. This would result in step 11. In step 7 the merchant validates the coupon from the buyer. In some embodiments the buyer is standing in the merchant's premises or in other embodiments the buyer may have electronically validated or emailed an order to the merchant.

Following step 7 either step 8, 9, or 10 occurs. In step 8 the buyer completes the purchase. The coupon number validates the price offered, earns the merchant and the buyer loyalty points if a loyalty system is in place, and can enable the system to track and issue rewards for completed transactions, such as rebates being offered to the merchant from the vendor for completing a transaction below the merchant's acceptable profit margin. Merchant Validation is the process through which the merchant scans the coupon (or enters its code) and is able to view the product and the offer. If the Offer Expiration Date has passed, the Merchant Validation may still be recorded but the only thing to appear on the screen will be that the offer expired on the Offer End Date. It is represented in formulae by MV.

In step 9 the buyer makes a partial purchase, either by choice, or through lack of funds at the time, or because the merchant did not have sufficient product in stock. In the case of a partial purchase, in some embodiments the offer for the balance remains current until the offer expires. The offer may be extended for a longer period of time. Examples of a partial sale include purchasing only a portion of the goods on the coupon.

In step 10 the merchant extends the expiration date of the offer by offering the buyer a rain check to be redeemed at a later time, for example when replacement stock arrives at the merchant's premises. The offer price will remain the same. A rain check is a merchant initiated offer where the Offer End Date is extended to a specific date because the product on the transaction is unavailable out of stock. In some embodiments, creating a Rain Check modifies an existing offer, it does not create a new offer. In some configurations, Rain Checks can also be extended. Step 10 may lead to a sale (step 8) or the offer expiring (step 11).

In step 11, no sale has been completed and the term of the offer has expired. In some embodiments, when no sale has been completed the system may require further information, such as through a no sale report or survey. A No Sale Report is a merchant or vendor generated report on what happened when a transaction was not completed. It is a short survey of two or three questions to record why a buyer came to a merchant, Merchant Validation took place, but no transaction was completed. It may ask a question such as:
a. Why did the customer not complete the transaction? Options such as:
   i. Buyer purchased competing produce.
   ii. Buyer decided not to buy at all.
   iii. Buyer did not have valid payment method.
   iv. Buyer opted to think about it.
   v. Other.

A No Sale Survey is an online survey of the buyer on what happened when a transaction was not completed. It is a short survey to record why a buyer came into a merchant, Merchant Validation took place, but no transaction was completed. It may ask a question such as:
a. Why did the customer not complete the transaction? Options such as:
   i. Buyer purchased competing produce.
   ii. Buyer decided not to buy at all.
   iii. Buyer did not have valid payment method.
   iv. Buyer opted to think about it.
   v. Other.

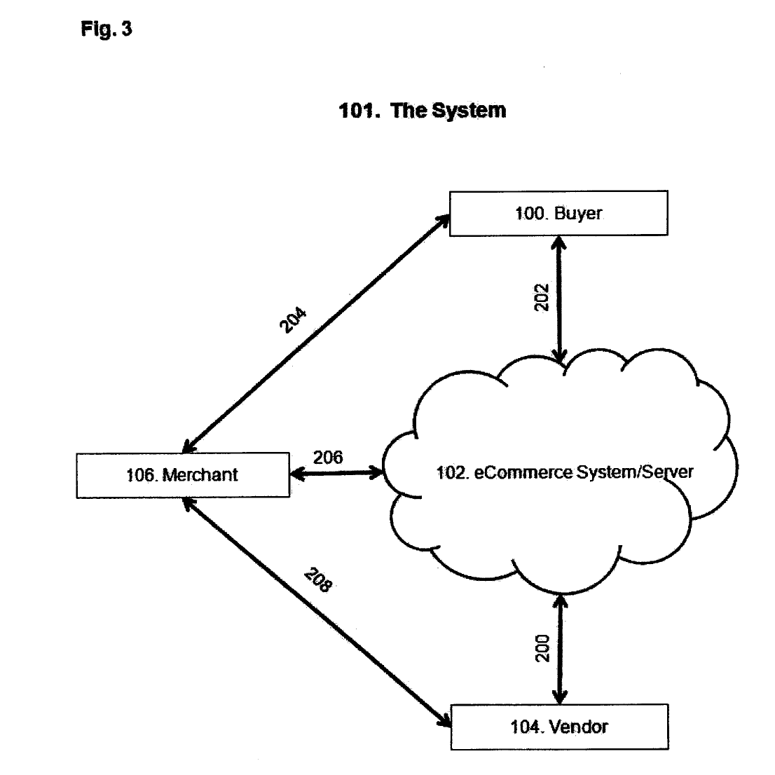

FIG. 3 shows one embodiment of the system 101. The system 101 includes the e-commerce system or server 102 and additional members which interact with or through the e-commerce system or server 102. The e-commerce system or server 102 may include data storage units, databases, means for communication across networks (both private and public), input and output devices, software and/or additional components. The buyer 100, vendor 104, and merchant 106 interact with the e-commerce system or server 102. Though certain interaction paths 200, 202, 204, 206, 208 are shown in FIG. 3, additional interactions between the different entities and additional entities may take place. Furthermore there may be any number of buyers 100, vendors 104, and merchants 106. There may also be any number of e-commerce systems or servers 102, working separately or as one server, however all of these components are shown singularly in FIG. 3 for simplicity.

A buyer may interact 202 with the server 102 to perform many activities such as register as a user, browse the server 102 for goods or services to place puts on, make a put, as shown in FIG. 1 step 1, and generate coupons as shown in step 5 of FIG. 1. Buyers 100 may interact 204 with merchants 106. These interactions 204 generally take place after a coupon has been generated (FIG. 1, step 5) to attempt completion of a transaction, either by browsing goods or by purchasing the goods after validating their coupon. Vendors 104 may interact 200 with the server 102. These interactions 200 may include registration with the system, entering products or goods, reviewing buyer puts, rejecting puts or making offers (FIG. 1 step 2 and step 3), invoicing and payment of commissions due to the promoter, or reviewing information gathered by the server 102.

The vendor 104 may also interact 208 with the merchant 106. These interactions 208 may include discussions regarding pricing, profit margins, acceptable prices and sale times, and stock information. Merchants 106 may interact 204, 206, 208 with the vendor 104 as described above, the buyer 100 as described above, and with the server 102. The merchant 106 may interact 206 with the server 102 while taking care of administrative matters to be a registered merchant, validating coupons (FIG. 1, step 7), and transmitting information back to the server 102 regarding whether or why a transaction either was or was not completed.

In some embodiments buyers 100 and vendors 104 do not directly interact, whereas in other embodiments they may. All the entities may interact with each other either through the server 102 or outside of the server 102 (whether depicted or not). Furthermore the interactions between the entities may be virtual or online, or in person. Interactions which are carried on virtually or online may take place through systems or software at the buyer 100, vendor 104, or merchant 106 locations, by the buyer 100, vendor 104, or merchant 106 accessing the server via a website or network connection, or by any other suitable method. Software or web access may be carried out using any suitable electronic device including but not limited to computers, mobile phones, PDAs, and other devices capable of accessing the server 102 or server's 102 information.

In yet another embodiment the system may function as described below still referring to the invention of FIG. 1.

The system or method begins in step 1 where the buyer makes a put on a product to the vendor. In some embodiments, when a buyer makes a put the system uses the buyers default location to locate merchants or vendors who can provide the product. However, if buyers would like to make purchases for others or in other areas they may enter other location parameters and distance ranges around the location for possible vendors or merchants to be chosen from. The system may use an internal or external search engine to allow for buyers to search for products using any criteria including but not limited to name, type, description, or technical specification.

As described above the buyer may be afforded anonymity by being identified in the system to the promoter with a unique buyer code, but in each transaction is identified to the vendor by a unique transaction buyer code. Each transaction may have a unique code relating to the transaction and each buyer may have a unique buyer code relating to each transaction. In some embodiments the transaction buyer code may have many components, such as incorporating a multiple digit buyer profile code that provides the vendor with information on the buyer. This information may include the buyer's status within the system and certain demographic and buying pattern data. The buyer Profile Code may function as a single identifier which classifies a buyer according to various parameters. In some embodiments the code may be a number, such as a 3-6 digit number with each digit representing a score out of (0-9) for various gradings (for example Loyalty, Frequency, Conversion Rate, Disposable Income, etc.). Different numbers of digits or grading values and fields may be used in different embodiments.

In some embodiments each transaction has a buyer Profile Code which identifies the buyer in these ways and a drill down profile on each buyer. A vendor considering making an offer on a low value item could use the buyer Profile Code in an algorithm. On a higher value transaction of something like a Motor Vehicle they may make individual assessments of a Buyer Profile Code by drilling down to lower levels of the data.

The buyer code, transaction buyer code, transaction code, and buyer profile code can be used to store and convey a variety of data. This data may include purchasing history, brand loyalty, transaction completion history, credibility, rank, and other data. A brand loyalty ranking may function as an assessment made of a buyer's propensity to stick with a preferred vendor for the same or similar items. It can be used by vendors on larger purchases to determine what offer may be made, and it could be used to maximize profits for the vendor. A buyer's loyalty towards a particular brand of one good, such as electronic equipment, may translate to brand loyalty in other goods, such as white goods or motor vehicles and the like, and be a valuable profiling tool.

An example of a credibility ranking system may be as follows. The Buyer Credibility Ranking may be a scale of 1-100 based on how many transactions a buyer completes when the offer matches or betters the put. In formulae it has the designation ‘CRb’. Buyers lose one point for every Matched Put not converted to a sale. A Matched Put is where a put is met with an offer of equal or lower value. While the buyer is unaware of their ranking, the vendor may be fully aware of it. When making a put the buyer is saying that if the vendor matches the put, the buyer will complete the transaction. While it does not materially matter that the buyer has not been truthful, and there could be many mitigating circumstances, it does give the vendor a clearer picture of which buyers are likely to be serious buyers and who will probably be Tyre Kickers (tire kickers), or those who are not serious about buying. Buyers redeem one point for every other transaction completed. The Buyer Credibility Ranking can never exceed 100. In some embodiments the buyer is never aware of their credibility ranking. In other embodiments the buyer may be aware of their credibility ranking. Other ranking systems may also be used.

Buyer information may also be used for other purposes. In one embodiment, buyer information may be used to provide discreet offers. A Discreet Offer is an unsolicited offer made to a discreet group of buyers based on the product of information gathered by the system. Statistics on the effectiveness of such an offer can also be recorded or tracked. Other systems or buyer information may also be used to create and provide discreet advertising packages to vendors or merchants to advertise to buyers. Additional information may be used to supplement buyer and system gathered information. For example online surveys may be provided to system users. These surveys may gather any subset of information including questioning buyers who do not complete transactions regarding why they were not completed.

Buyer credibility information may be used to create a ranking system for vendors or merchants (or even buyers) to view. One example of a ranking code system groups buyers according to their credibility within the system. Visually it may be represented as color coded sections on a graph or chart. Electronically it may be an assigned value, normally generated automatically from data collated from transactions. One example of the ranking system would rank buyers as follows: Blue—Exemplary credibility, Green—Normal credibility, Yellow—Downward trend suggesting buyers are still feeling their way, Orange, Red—Tyre Kickers, and Black—Suspected of Industrial Espionage. Algorithms and information may also be used to categorize buyers into other categories based on any data within the system. Some data sets may include market information, buying information, and information which may show that a buyer is an industry spy using an account to determine competitor offers or to influence competitor offer values. For example, a spy is a buyer that has been deduced was established by a competitor to determine what a competitor is doing with puts. In some configurations, several criteria may be used to deduce that this particular buyer is not genuine but one criteria may be that several buyers use the same IP address to make puts with the same vendor at the same time. The merchant or vendor may be provided with an algorithm builder feature allowing the vendor or merchant to establish parameters for a search and resulting report or information gathered by the system.

In one embodiment, matching the put from the buyer to the product of the vendor classified by region, country, sub-region and local community may be shown by this algorithm:

Put=(BuID+PrID+[CoID:BuZip])×CuRateNow

Where:
a. Put Is the value of the put in the local currency of the buyer.
b. BuID Is the buyer identification code.
c. PrID Is the product identification code.
d. CoID Is the country identification code.
e. BuZip Is the buyer's post code.
f. CuRateNow Is the current currency conversion rate from the buyer's local currency to the currency used by the vendor in financial transactions.

In some embodiments, the buyer profile code, which is a component of the transaction code, is a multiple digit number with each digit representing a score out of 10 (0-9) for certain criteria. The Product Code or product ID code is a unique number assigned to every product on the system. It is defined by the system, not any vendor, but it relates directly to a Vendor's Product Code. Products may include images. A product image is a digital representation of a product that is used electronically, such as on the web. A product may have no images, one image, or more than one Product Image. In some embodiments, each image is classified for content control.

In some embodiments the algorithm to create a buyer profile code would be:

BuPC=Concatenate[BuID:BpLoy]+[BuID:BpFreq]+[BuID:BpConv]+[BuID:BpDem]+[BuID:BpOthern]

Where:
a. BuPC Is the buyer profile code.
b. BuID Is the buyer identification code.
c. BpLoy Are the brand loyalty characteristics of the buyer.
d. BpFreq Is the frequency of use of the system by the buyer.
e. BpConv Is the average conversion rate from put to closed transaction for this buyer.
f. BpDem Is the demographic data available on this buyer.
g. BpOtherⁿ Is other criteria (and other digits) that may be added to the buyer profile code from time to time.

In some embodiments, the following algorithm may be used to create a unique transaction code:

TrID=Concatenate VrID+PrID+BuID+[BuPC]+[DeP]

Where:
a. TrID Is the unique transaction code linked to the buyer for this transaction alone.
b. VrID Is the vendor's identification code.
c. PrID Is the product code.
d. BuID: Is the buyer's identification code.
e. BuPC Is the buyer profile code.
f. DeP Is the offer expiration date of the put.

After step 1 the vendor may proceed by either executing step 2 or 3. In step 2 the vendor has the option of ignoring the put for any variety of reasons including if it considers the value of the put unrealistic or if the system has determined that the buyer is not a serious purchaser, or if the buyer appears to be using the system to drive a price down, or if the buyer has been identified as being involved in some form of commercial espionage. Once the put is ignored, nothing else happens within the system in relation to this put, the result is the system progressing to step 11. A buyer may cancel a put at any time prior to an offer related to that put being issued. This allows the buyer to make a different put. In some embodiments, if an offer is made against a put, the buyer cannot make another put on the same product until the original offer expires.

In step 3, after optionally reviewing all puts made on that particular product at this point in time, and any data gathered on the buyer, such as demographics and prior buying patterns, the vendor makes an offer back to the buyer and, if desired, imposes a time limit on that offer. In some embodiments a verification procedure may be put in place allowing vendors to verify buyers. For example, if a vendor is not comfortable passing information on to a buyer because they suspect they are competitors or if they require additional qualifying information, they can request the system to contact the buyer, by any means of communication. The data received may be stored on the Buyer Profile for future use but to preserve privacy the system may allow for functions to prevent passing of the exact gathered data on to the vendor.

The vendor has the benefit of being able to review how buyers from all over the globe value their product in any particular time frame, and using that and other information to determine the optimum price to be offered.

In some embodiments, a vendor considering making an offer on an item may automate the process by using the transaction code in an algorithm. In one embodiment, an algorithm for automating this process would be:

If [Avg[Putⁿ:Valid]]>=[PrID:OfferMin], then Offer=Yes to all if Offer is greater than [PrID:OfferMin], else [Offer=[PrID:OfferMin][RptExcMktValue:[Avg[Putn:Valid]]<=[PrID:OfferMin]

Where:
a. Putⁿ:ValidIs all puts that have not been excluded for that day for that product.
b. PrID Is the product identification number.
c. OfferMin Is the minimum price that the vendor has set for an offer made on that product.
d. Offer Is the price offered in response to a put.
e. RptExcMktValue An exception report where the average put price for that product for that day is less than the minimum price that the vendor has set for an offer made on that product. This lets the vendor decide if they want to adjust the minimum price set for an offer made on that product, to meet these new market expectations.

After step 3, either step 4 or step 5 is taken. In step 4, the buyer can ignore the offer and do nothing, leading to step 11. There is no obligation on the buyer to make a purchase but, in some embodiments, their activities will be tracked and if they make repeated puts for the same product in an effort to drive the price down, they can be identified to the vendor and the vendor may give them the same price they were offered last time or no price at all. In some embodiments, the algorithm for this process is as follows:

If [BuID:Put:PrID:DeO¹]>[BuID:Put: PrID:DeO²], Offer:DeO¹,else [Offer: PrID:DeO²]

Where:
a. BuID Is the buyer identification code.
b. PrID Is the product identification number.
c. Put:PrID:DeO1 Is the value of the first put made.
d. Put:PrID:DeO2 Is the value of the second offer made and the new expiration date of that offer.
e. Offer:PrID:DeO1 Is the value of the offer made to the original put and the date the original offer expired, which the vendor can opt to offer again, or offer at different price with a new expiration date.

In step 5 the buyer can generate a coupon. In some embodiments this coupon may contain information or data which can be used to identify the buyer, the product, the offer and the offer expiration date. This coupon may be transferred to the merchant and vendor in any manner, such as physically or electronically. In some embodiments the coupon does not plainly display the product name or price. Not displaying this information forces the merchant to validate the coupon, with the system, to find out what price has been quoted for what product in the offer. Once validated, the system knows the buyer is interacting with the merchant. In some embodiments, the system may allow for vendors to provide new offers to a buyer if the buyer has not completed the transaction.

Following step 5, either step 6 or step 7 occurs. In step 6 the buyer may choose not to proceed with the transaction, resulting in step 11, without even presenting the coupon to the vendor's participating merchant. Nothing further happens within the system until the offer expires.

In step 7 the merchant validates the coupon from the buyer. This may mean the buyer is standing in the merchant's premises, interacting with the merchant online, or may have emailed an order to the merchant. In some embodiments, the algorithm related to the transaction is as follows:

If MeID×TrID, then TrVal, else TrStet

Where:
a. MeID Is the merchant ID.
b. TrID Is the unique transaction code linked to the buyer for this transaction alone.
c. TRVal Validates the coupon.
d. TRStet Transaction stands unchanged.

Following step 7 either step 8, 9, or 10 occurs. In step 8 the buyer completes the purchase. The coupon validates the price offered. This validation data can be used in some embodiments to earn the merchant and buyer loyalty points or to offer rebates to the merchant from the vendor for completing a transaction below the merchant's acceptable profit margin. In some embodiments, the algorithms related to the transaction may be as follows:

For Merchant Loyalty Points: [TrID:Offer:TrSalePrice]×[MeID:MeLoy]

Where:
a. TrID Is the unique transaction code linked to the buyer for this transaction alone.
b. Offer Is the price offered in response to a put.
c. TRSalePrice Is the value of the transaction.
d. MeID Is the merchant ID.
e. MeLoy Is the number of loyalty points per USD value of the transaction a merchant earns for completing the transaction.

And: For Buyer Loyalty Points: [TrID:Offer TrSalePrice]×[BuId:BuLoy]

Where:
a. TrID Is the unique transaction code linked to the buyer for this transaction alone.
b. Offer Is the price offered in response to a put.
c. TRSalePrice Is the value of the transaction.
d. BuID Is the buyer ID.
e. BuLoy Is the number of loyalty points per USD value of the transaction the buyer earns for completing the transaction.

For merchant rebates: MERebate=If ([TrID:Offer]−[MeID:PrID:PrCost])/[TrID:Offer]<([TrID:Offer]×[MeID:MeMinMargin]), then ([TrID:Offer]×[MeID:MeMinMargin]−([TrID:Offer]−[MeID:PrID:PrCost])

Where:
a. MeRebate Is the merchant rebate
b. TrID Is the unique transaction code linked to the buyer for this transaction alone.
c. Offer Is the price offered in response to a put.
d. MeID Is the merchant ID.
e. PrID Is the product identification number.
f. PrCost Is the product cost.
g. MeMinMargin Is the minimum margin agreed between the vendor and the merchant.

In step 9 the buyer makes a partial purchase. A partial purchase may happen for any reasons such as by choice, through lack of funds at the time, or because the merchant did not have sufficient product in stock. In the case of a partial purchase, the offer for the balance remains current until the offer expires. The same algorithms apply as used in step 8.

In step 10 the merchant extends the expiration date of the offer by offering the buyer a rain check to be redeemed when replacement stock arrives at the merchant's premises. The offer price will remain the same. Step 10 may lead to a sale (step 8) or the offer expiring (step 11). In some embodiments, the algorithm related to the transaction is as follows:

If [DeO]<[Now], then [MePIN], then [DeO²]

Where:
a. DeO Is the offer expiration date.
b. Now Is the current date.
c. MePIN Is the merchant's PIN code with the authority to extend an offer date.
d. Deo² Is the new offer expiration date.

In step 11, no sale has been completed and the term of the offer has expired. In some embodiments, the algorithm related to the transaction is as follows:

If [DeO]>[Now], then [TrExp], else [TrStet]
Where:

a. DeO Is the offer expiration date.
b. Now Is the current date.
c. TrExp Sets the transaction to expired.
d. TRStet Transaction stands unchanged.

In some configurations, embodiments may include advantages including, without limitation, features which may allow the vendor to achieve the following:
a. Gather information regarding what market forces are driving prices on any given day.
b. Establish the true value of any item based on supply and demand globally.
c. Maximize profits by matching prices to verifiable demand figures.
d. Offer discounted prices to reduce inventory if desired.
e. Offer discounted prices to close more sales within a defined time period.
f. Not offer discounts where demand indicates it is not warranted.
g. Minimize advertising expenditure on campaigns that are not needed or wanted by the buyer.

Also without limitation, the buyer may be able to:
a. Participate in establishing the true value of an item.
b. Make a realistic put that should lead to obtaining the best possible deal for a particular product at a particular point in time.
c. Transact genuine business over the internet without disclosing personal information.
d. Negotiate a firm, attractive price on an item without having to be face to face with the merchant.
e. Do business without disclosing credit card information over the Internet.
f. Purchase the desired product from a local merchant.
g. See and touch the product before making the final decision to buy.
h. Support the local business community by directing business to local merchants.
i. Potential buyers are able to make a put on a product with no obligation. They can negotiate while protecting the privacy of their identity, how serious they are, their economic status, and what their IP address is. Though some of this data may be stored within the system, merchants and vendors may not be privy to it.
j. Conserve energy, gasoline, or reduce their carbon footprint because they would only need to, at most, travel to one merchant to make a purchase, having completed all negotiations and shopping from their home on a computer.

Also without limitation, the merchant may be able to:
a. Reduce advertising expenditure.
b. Not have to make unrealistic sale prices that reduce profits.
c. Reduce inventory or share inventory with other merchants in the community.
d. Keep jobs in the community.
e. Obtain add-on sales when new customers come in to their stores to finalize a transaction.

While the foregoing written description of the invention enables one of ordinary skill to create and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

We claim:

1. An e-commerce method, comprising:
accepting an item listing for sale;
receiving at least one put on the item listing;
providing the at least one put for evaluation;
receiving a response to the at least one put; and
providing an output of the response, as a coupon, to be redeemed at a merchant, if valid.

2. The method of claim 1, in which the response to the at least one put is one of: acceptance, counter offer or rejection.

3. The method of claim 1, in which the coupon is either in physical or virtual form.

4. The method of claim 1, in which the at least one put is received from a buyer.

5. The method of claim 4, further comprising anonymizing buyer information.

6. The method of claim 4, further comprising tracking buyer information.

7. The method of claim 6, further comprising marketing items to the buyer based on the tracked buyer information.

8. The method of claim 6, further comprising creating a buyer profile based on the tracked buyer information.

9. The method of claim 6, further comprising providing discreet offers to the buyer based on the tracked buyer information.

10. The method of claim 1, in which the item listing does not originate with the merchant.

11. The method of claim 1, further comprising automating the put response.

12. The method of claim 1, further comprising calculating item value based on the received puts.

13. The method of claim 1, in which the at least one put has a validity term.

14. The method of claim 1, in which the response to the at least one put has a validity term.

15. The method of claim 1, in which the item listings include classification information.

16. The method of claim 1, further comprising validating the coupon at redemption.

17. The method of claim 1, further comprising accepting information regarding coupon redemption.

18. The method of claim 1, further comprising providing a response to an item listing search.

19. The method of claim 1, further comprising rewarding loyalty points after the coupon is redeemed.

20. An e-commerce system operable on a server computer and accessible through a computer network, comprising:
an item listing unit which stores information about items for sale;
a buyer put unit which accepts at least one buyer put on the listed items;
a vendor offer unit which accepts vendor offers in response to the buyer puts; and
a coupon output unit which outputs coupons representing vendor offers.

21. The system of claim 20, in which the coupon is either in physical or virtual form.

22. The system of claim 20, in which the buyer put unit further anonymizes buyer information.

23. The system of claim 20, further comprising a tracking unit which tracks buyer information.

24. The system of claim 23, further comprising a marketing unit which markets items to the buyer based on the tracked buyer information.

25. The system of claim 23, in which the tracking unit further creates a buyer profile based on the tracked buyer information.

26. The system of claim 24, in which the marketing unit further provides discreet offers to the buyer based on the tracked buyer information.

27. The system of claim 20, in which the vendor offer unit further automates the generation of vendor offers.

28. The system of claim 20, further comprising a calculation unit which calculates item value based on received buyer puts.

29. The system of claim 20, in which the stored item information includes classification information.

30. The system of claim 20, a validation unit which validates the coupon at coupon redemption.

31. The system of claim 20, in which the vendor does not redeem coupons.

32. A computer program product, comprising:
a non-transitory computer-readable medium comprising:
code for accepting an item listing for sale;
code for receiving at least one put on the item listing;
code for providing the at least one put for evaluation;
code for receiving a response to the at least one put; and
code for providing an output of the response, as a coupon, to be redeemed at a merchant, if valid.

33. The computer program product of claim 32, in which the response to the at least one put is one of: acceptance, counter offer or rejection.

34. The computer program product of claim 32, in which the at least one put is received from a buyer.

35. The computer program product of claim 34, further comprising code for anonymizing buyer information.

36. The computer program product of claim 34, further comprising code for tracking buyer information.

37. The computer program product of claim 36, further comprising code for marketing items to the buyer based on the tracked buyer information.

38. The computer program product of claim 36, further comprising code for creating a buyer profile based on the tracked buyer information.

39. The computer program product of claim 32, in which the item listing does not originate with the merchant.

40. The computer program product of claim 32, further comprising code for automating the put response.

41. The computer program product of claim 32, further comprising code for calculating item value based on the received puts.

42. The computer program product of claim 32, in which the item listings include classification information.

43. The computer program product of claim 32, further comprising code for validating the coupon at redemption.

44. The computer program product of claim 32, further comprising code for accepting information regarding coupon redemption.

45. The computer program product of claim 32, further comprising code for providing a response to an item listing search.

46. The computer program product of claim 32, further comprising code for rewarding loyalty points after the coupon is redeemed.
